(19) United States
(12) Patent Application Publication
(10) Pub. No.: US 2009/0232342 A1
(43) Pub. Date: Sep. 17, 2009

(54) EARBUD ADAPTER WITH INCREASED FLEXIBILITY REGION

(75) Inventors: Robert J. Oliveira, Maplewood, MN (US); Martin P. Babcock, White Bear Lake, MN (US); Michael T. Venem, St. Paul, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: HEARING COMPONENTS, INC., Oakdale, MN (US)

(21) Appl. No.: 12/048,835

(22) Filed: Mar. 14, 2008

(51) Int. Cl. H04R 25/00

(52) U.S. Cl. 381/382

(57) ABSTRACT

An adapter configured to be detachably coupled to an earbud-type sound device or other sound device is disclosed. The adapter includes an adapter body having a top portion, a bottom portion which is configured to be detachably coupled to a sound device, and a projection extending from the top portion at a junction region between the projection and the top portion of the adapter body. The projection includes a sound conduit extending from an opening in the top portion of the adapter body. Furthermore, the junction region includes a multi-directional positioning component allowing the projection to be positioned at a plurality of angular positions relative to the top portion of the adapter body.

### TECHNICAL FIELD

The present disclosure pertains to sound devices and adapters or devices for use with sound devices. More particularly, the present invention pertains to adapters for use with earbud-type headphones that provide a universal fit, improve the comfort of the headphones, and/or isolate the ear from extraneous sounds.

### BACKGROUND

Sound devices such as headphones are used extensively throughout the world. One style of headphones that is commonly used is referred to as an earbud or an earbud-type headphone. Earbuds (i.e. earphones) are small speaker-like devices that are designed to fit within the external ear of a listener so that the user can listen to sound being transmitted from a sound source. Some examples of typical sound sources where earbuds may be used include personal and/or portable audio players (including radios, cassette players, compact disc players, portable mp3 players, etc.), portable DVD players, telephones (including wireless and cellular-type telephones), etc. When properly positioned in the ear, earbuds can provide the listener with acceptable sound transmission to the ear canal. However, due to person-to-person variations and variations in the environment in which the earbuds are used, fit may not be adequate and extraneous noise may make transmission inadequate.

A wide variety of headphones and earbuds (i.e. earphones) have been developed as well as a number of adapters and prostheses attachable to these devices. In addition, a wide variety of methods for manufacturing headphones (including earbuds) and adapters have been developed. Among these known devices and methods, each has certain advantages and disadvantages.

Adapters for use with earbuds, as well as earbud devices with integral sound tubes, are intended to channel sound transmitted from the driver (e.g., speaker) of the sound device into the ear canal of a user. However, it is noted that the auditory anatomy of one individual may vary greatly from the auditory anatomy of another individual, thus frustrating the ability for a single adapter configuration to fit properly for a wide variety of users.

There is an ongoing need to provide alternative devices and methods for making these devices which are configured to be adaptable for use in the diverse auditory anatomy of a wide range of users.

### SUMMARY

The present disclosure relates to sound devices and adapters and/or prostheses for use with sound devices.

Accordingly, one illustrative embodiment is an adapter configured to be detachably coupled to an earbud-type sound device or other sound device. The adapter includes an adapter body having a top portion, a bottom portion which is configured to be detachably coupled to a sound device, and a projection extending from the top portion at a junction region between the projection and the top portion of the adapter body. The projection includes a sound conduit extending from an opening in the top portion of the adapter body. Furthermore, the junction region includes a region of enhanced flexibility, such as a multi-directional positioning component, allowing the projection to be positioned at a plurality of angular positions relative to the top portion of the adapter body.

In some instances, the projection may be oriented in a first position in which the projection extends from the top portion of the adapter body at a first angular orientation relative to the top portion, wherein an applied force applied to the projection moves the projection to a second position in which the projection extends from the top portion of the adapter body at a second angular orientation relative to the top portion. The projection may be biased to return to the first position from the second position when the applied force is removed.

Another illustrative embodiment is an adapter configured to be attached to an earbud-type sound device. The adapter includes a dome-shaped wall configured to be disposed adjacent a speaker face of the earbud-type sound device and a projection extending at an angle from the dome-shaped wall at a junction region between the projection and the dome-shaped wall. The projection includes a sound conduit for directing sound through the projection into an ear canal of a user. Furthermore, the junction region between the projection and the dome-shaped wall includes a multi-directional positioning component allowing the projection to be positioned at a plurality of angular positions relative to the dome-shaped wall in order that the adapter can fit comfortably in a variety of different users' ears.

The above summary of some example embodiments is not intended to describe each disclosed embodiment or every implementation of the invention.

### BRIEF DESCRIPTION OF THE DRAWINGS

The invention may be more completely understood in consideration of the following detailed description of various embodiments in connection with the accompanying drawings, in which:

FIGS. 1 and 2 are perspective views of an exemplary adapter which may detachably coupled to an earbud-type sound device or other sound device;

FIGS. 1A and 1B are cross-sectional views of the adapter of FIGS. 1 and 2 illustrating two possible orientations of the projection relative to the top portion of the adapter body;

FIG. 3 is a perspective view of a variation of the adapter of FIGS. 1 and 2;

FIGS. 3A and 3B are cross-sectional views of the adapter of FIG. 3 illustrating two possible orientations of the projection relative to the top portion of the adapter body;

FIG. 4 is a perspective view of another variation of the adapter of FIGS. 1 and 2;

FIGS. 4A and 4B are cross-sectional views of the adapter of FIG. 4 illustrating two possible orientations of the projection relative to the top portion of the adapter body;

FIG. 5 is a perspective view of another variation of the adapter of FIGS. 1 and 2;

FIGS. 5A and 5B are cross-sectional views of the adapter of FIG. 5 illustrating two possible orientations of the projection relative to the top portion of the adapter body;

FIG. 6 is a perspective view of yet another variation of the adapter of FIGS. 1 and 2;

FIGS. 6A and 6B are cross-sectional views of the adapter of FIG. 6 illustrating two possible orientations of the projection relative to the top portion of the adapter body;

FIG. 7 is a perspective view of another variation of the adapter of FIGS. 1 and 2;

FIGS. 7A and 7B are cross-sectional views of the adapter of FIG. 7 illustrating two possible orientations of the projection relative to the top portion of the adapter body;

FIGS. 8A and 8B are cross-sectional views of another variation of the adapter of FIGS. 1 and 2 illustrating two possible orientations of the projection relative to the top portion of the adapter body;

FIGS. 9A and 9B are cross-sectional views of another variation of the adapter of FIGS. 1 and 2 illustrating two possible orientations of the projection relative to the top portion of the adapter body;

FIGS. 10A and 10B are cross-sectional views of yet another variation of the adapter of FIGS. 1 and 2 illustrating two possible orientations of the projection relative to the top portion of the adapter body;

FIG. 11 is a cross-sectional view illustrating an adapter detachably coupled to the housing of an earbud-type sound device; and

FIG. 12 is a transverse cross-sectional view illustrating an adapter, detachably coupled to an earbud-type sound device, positioned in the auditory anatomy of a user.

While the invention is amenable to various modifications and alternative forms, specifics thereof have been shown by way of example in the drawings and will be described in detail. It should be understood, however, that the intention is not to limit aspects of the invention to the particular embodiments described. On the contrary, the intention is to cover all modifications, equivalents, and alternatives falling within the spirit and scope of the invention.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

Adapters disclosed herein may be used with an earbud or an earbud-type sound device or earphone. Additional adapters, which may be used with an earbud or an earbud-type sound device are disclosed in application Ser. No. 10,753,591 entitled “Earbud Adapter” filed Jan. 7, 2004, and application Ser. No. 10/686,849 entitled “Earbud Adapter With Enhanced Frequency Response” filed Mar. 15, 2007, of which the discloses are incorporated herein by reference.

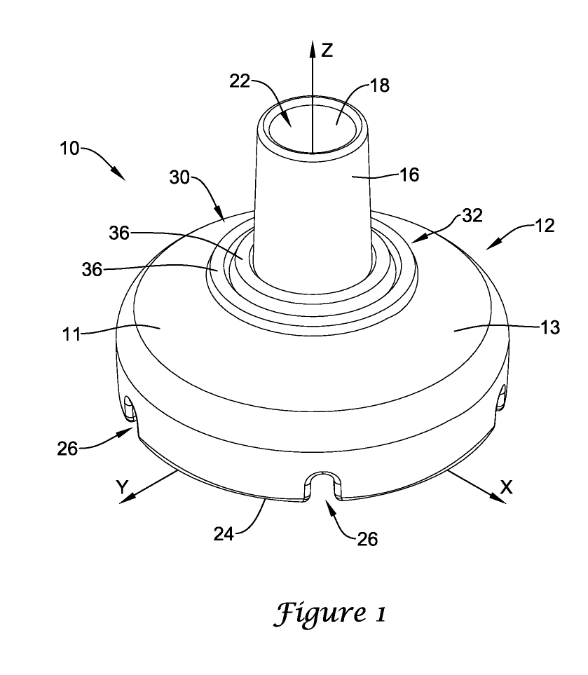

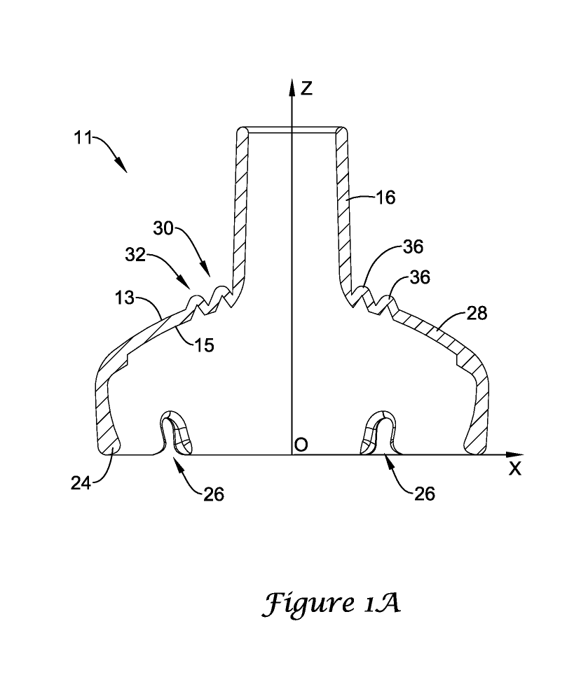

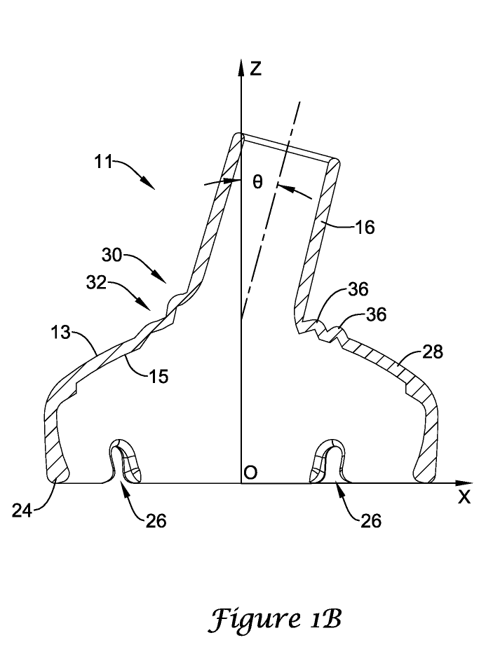

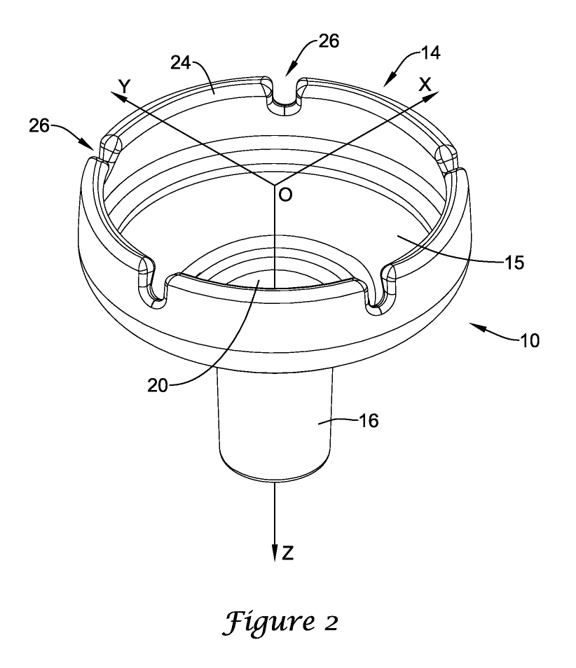

FIGS. 1 and 2 are perspective views of an example adapter 10 for use with an earbud or an earbud-type sound device or earphone. The adapter 10 includes an adapter body 11 including a top portion or side 12 including a first surface 13, as best seen in FIG. 1, and an opposing second surface 15, as best seen in FIG. 2, and a bottom portion or side 14 including a coupling portion, as best seen in FIG. 2. In some embodiments, the top portion 12 may include a dome-shaped wall 28 including the first surface 13 and the second surface 15. In some embodiments, the first surface 13 of the dome-shaped wall 28 may be a convex surface and/or the second surface 15 may be a concave surface.

A projection or sound port 16 extends from the first surface 13 of the top portion 12. A port opening 18 is defined in the projection 16. In some embodiments, the opening 18 is at the distal terminus of the projection 16. In other embodiments, the opening 18 can be disposed at other locations along the projection 16. A second opening 20 is defined in the adapter body 11 that is disposed on the second surface 15 of the top portion 12 within the cavity formed in the adapter body 11. A sound conduit 22 is defined in the adapter body 11 that extends through the projection 16 between the first opening 20 and the second opening 18. The sound conduit 22 generally allows sound (acoustical energy) to pass from a driver (e.g., a speaker) of a sound device (to which adapter body 11 is detachably coupled to), into and through the opening 20, through the projection 16, through and out from the opening 18, and into the ear canal of a user. Thus, the sound conduit 22 directs acoustical energy output from the driver of a sound device into the ear canal of a user.

The adapter body 11 is configured to be attachable to an earbud or earbud-type sound device. An earbud or earbud-type device, otherwise known as an earphone, is one that normally rests within the outer ear, such as in the bowl of the concha, during use. Preferably, the adapter body 11 is configured for being detachably connectable to a sound device. When describing the adapter body 11 as being detachably connectable or removably coupled to an earbud, what is meant is that the adapter body 11 may be selectively removed from the earbud throughout normal usage of the device without causing unintended damage or harm to either the adapter 10 or the earbud. The adapter body 11 may include a coupling portion for coupling the adapter 10 to a housing of a sound device. This feature allows a user to freely attach and detach the adapter 10 as desired. However, the adapter body 11 is held in place with sufficient force to retain its position on the sound device during use. The adapter 10 may be exchanged for another adapter as desired in instances where the sound device is used by multiple users and/or in different environments. In addition, the user may discard the adapter 10 after use, if desired, and replace it with a new one for subsequent uses. The earbud or earbud-type sound device may be a part of a cell phone headset, CD player or any other sound transmission device. It may include one or more ear buds.

The materials used to manufacture the adapter body 11 may vary. In some embodiments, the adapter body 11 is made from a polymer. Because a number of polymers are relatively inexpensive, constructing the adapter body 11 from a polymer may desirably impact the manufacturing costs. In addition, because of the relatively low manufacturing costs that are contemplated, the adapter body 11 may be inexpensive for the consumer and disposable. Some examples of suitable polymers include a thermoplastic elastomer such as a mixture of EPDM (ethylene propylene diene monomer) rubber and polypropylene sold under the tradename SANTOPRENE®, or a thermoplastic elastomer based on styrene and isoprene sold under the tradename KRATON®. Other examples of suitable polymers may include ethylene tetrafluoroethylene (ETFE), fluorinated ethylene propylene (FEP), polyoxymethylene (POM), polybutylene terephthalate (PBT), polyether block ester, polyurethane, polypropylene (PP), polyvinylchloride (PVC), polyether-ester (for example, a polyether-ester elastomer such as ARNITEL® available from DSM Engineering Plastics), polyester (for example a polyester elastomer such as HYTREL® available from DuPont), polyamide (for example, DURETHAN® available from Bayer or CRISTAMID® available from Elf Atochem), elastomeric polyamides, block polyamide/ethers, polyether block amide (PEBA, for example, available under the trade name PEBAX®), silicones, polyethylene (PE), Marlex high-density polyethylene, Marlex low-density polyethylene, linear low density polyethylene (for example, REXELL®), acrylonitrile butadiene styrene (ABS), polyethylene terephthalate (PET), polyimide (PI), polyetherimide (PEI), polyphenylene sulfide (PPS), polyphenylene oxide (PPO), nylon, perfluoro(propyl vinyl ether) (PFA), other suitable materials, or mixtures, combinations, copolymers thereof, polymer/metal composites, and the like. In some embodiments, the selected material may be chosen for its durometer hardness characteristics and/or its availability in several grades of durometer hardness.

As suggested above, the bottom portion 14 is configured so that the adapter body 11 can releasably attach to a sound device. In some embodiments, the bottom portion 14 can include a coupling portion, such as a ridge or rim 24 that is adapted to fit over and generally be disposed along the perimeter of the earbud or earbud-type sound transmitting device. It can be seen in FIG. 2 that the rim 24 may be generally circular or annular in shape so as to correspond to the generally circular and/or conical shape of the housing of a sound device. However, other shapes are contemplated, depending on the shape of the sound device. For example, the rim 24 could be oval, squared, polygonal, etc. so as to improve the compatibility, attachability, and detachability of the adapter body 11 to a variety of sound devices. In addition, one or more notches 26 may be defined in the rim 24, which can allow the rim 24 to adjust to somewhat differently sized or shaped sound devices and allow the adapter body 11 to more easily attach and detach from the sound device while providing a sufficient interference fit, such as frictional or interlocking engagement. The one or more notches 26 may provide the rim 24 with a plurality of discontinuous segments, such as discontinuous arcuate segments around the perimeter of the bottom portion 14 of the adapter body 11. This feature may allow a consumer to use one particular adapter 10 embodiment with a number of differently sized or shaped sound devices. In some embodiments the material selected for the adapter body 11 may be sufficiently elastic such that the adapter body 11 may be stretched over the housing of a sound device and retained thereon.

The adapter body 11, including the top portion 12 (e.g., the dome-shaped wall 28), the bottom portion 14 (including the rim 24), and/or the projection or sound port 16 may be a one-piece, monolithic component. For example, the top portion 12, the bottom portion 14 and/or the projection or sound port 16 may be molded or otherwise formed of a single piece of material, such as molded of a single piece of polymeric material which may include one or more material compositions.

In some embodiments, the projection or port 16, or at least a portion thereof, is generally configured for extending into the ear canal of a user during use. It is noted that the auditory anatomy of a user, including the orientation of the ear canal of the ear relative to the concha of the ear may vary greatly from one user to the next. In order for the projection 16 to be properly positioned and/or seated in the ear canal of an individual user, the projection 16 may be positioned at a plurality of angular positions relative to the top portion 12 (e.g., the dome-shaped wall 28) of the adapter body 11.

To this end, the adapter body 11 may include a junction region 30 located between the projection 16 and the top portion 12 (e.g., the dome-shaped wall 28) of the adapter body 11. In some embodiments, the junction region 30 may be a radiused region located between the projection 16 and the top portion 12. The junction region 30 may include a concave surface extending around the longitudinal axis of the projection 16 uniting the outer surface of the projection 16 with the first or upper surface 13 of the top portion 12 of the adapter body 11.

The junction region 30 may include a region of enhanced flexibility providing multi-directional angular orientation of the projection 16 relative to the top portion 12 of the adapter body 11 at the junction region 30. For example, the junction region 30 may include a multi-directional positioning component 32 allowing the projection 16 to be positioned at a plurality of angular positions relative to the top portion 12 (e.g., the dome-shaped wall 28) of the adapter body 11.

FIGS. 1 and 2 show the adapter 10 placed in a three-dimensional XYZ Cartesian coordinate system having an origin O, an X-axis extending from the origin O, a Y-axis extending from the origin O and perpendicular to the X-axis, and a Z-axis extending from the origin O and perpendicular to both the X-axis and the Y-axis.

As shown in FIGS. 1 and 2, the rim 24 of the bottom portion 14 of the adapter body 11 may lie in the XY plane of the XYZ coordinate system. The longitudinal axis of the projection 16 may extend at an angle to the XY plane of the XYZ coordinate system. For instance, as shown in FIGS. 1 and 2, the longitudinal axis of the projection 16 may extend along the Z-axis of the XYZ coordinate system. The multi-directional positioning component 32 may allow the longitudinal axis of the projection 16 to be positioned at a plurality of angular positions relative to the XY plane of the XYZ coordinate system. For instance, the multi-directional positioning component 32 may allow the longitudinal axis of the projection 16 to angle away from the Z-axis in a plurality of directions and/or a plurality of angles. In some embodiments, the angle of the longitudinal axis of the projection 16 may be altered by about 5 degrees or more, 10 degrees or more, 15 degrees or more, 25 degrees or more, 30 degrees or more, or 45 degrees or more between a first position and a second position. In some embodiments, the multi-directional positioning component 32 may be an omni-directional positioning component allowing omni-directional angular orientation of the projection 16 relative to the top portion 12 of the adapter body 11. For example, in some embodiments, the multi-directional positioning component 32 may allow the projection 16 to angle away from the Z-axis in all angular directions.

In some embodiments, the projection 16 may be oriented in a first position in which the projection 16 extends from the top portion 12 of the adapter body 11 at a first angular orientation relative to the top portion 12. When an external force is applied to the projection 16, the projection 16 may move to a second position in which the projection 16 extends from the top portion 12 of the adapter body 11 at a second angular orientation relative to the top portion 12. In some embodiments, the projection 16 is biased to return to the first position from the second position when the applied force is removed. In other embodiments, the projection 16 may remain in the second position when the applied force is removed.

As an illustrative example, in some embodiments the position in which the longitudinal axis of the projection 16 lies along the Z-axis is an equilibrium position, such that when an applied force moving the projection 16 to a second position in which the longitudinal axis of the projection 16 is angled away from the Z-axis is removed, the projection 16 is biased to return to the equilibrium position, and thus the projection 16 returns to an orientation in which the longitudinal axis of the projection 16 lies along the Z-axis.

In FIGS. 1 and 2, the multi-directional positioning component 32 is illustrated as one or more, or a plurality of bellows or pleats 36 of material located in the junction region 30. The bellows or pleats 36 may extend around at least a portion of the junction region 30. For example, the bellows 36 may extend circumferentially around the longitudinal axis of the projection 16 in the junction region 30. As shown in FIG. 1, the bellows 36 may be formed in the dome-shaped wall 28 proximate the projection 16.

FIGS. 1A and 1B are cross-sectional views of the adapter body 11 taken along the XZ plane of FIG. 1, with the Y-axis coming out of the page. As shown in FIGS. 1A and 1B, the bellows 36 allow the longitudinal axis of the projection 16 to be positioned at a plurality of angular positions relative to the top portion 12 of the adapter body 11. For example, in FIG. 1A, the longitudinal axis of the projection 16 is shown extending along the Z-axis and in FIG. 1B, the longitudinal axis of the projection 16 is shown extending at an angle, such as an acute angle, to the Z-axis. It can be seen from FIGS. 1A and 1B, that the bellows 36 allow the longitudinal axis of the projection 16 to be positioned at a plurality of angular orientations relative to the XY plane of the XYZ coordinate system.

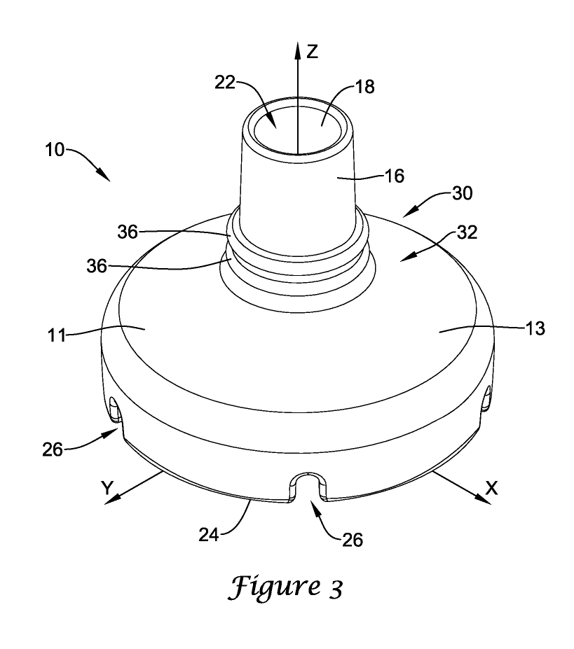

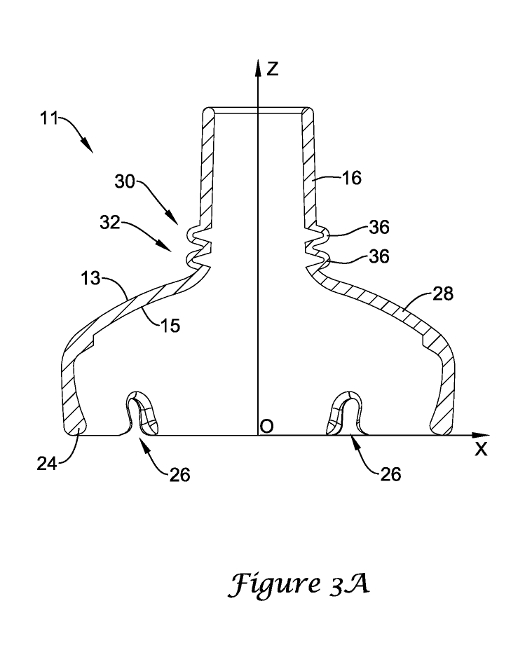

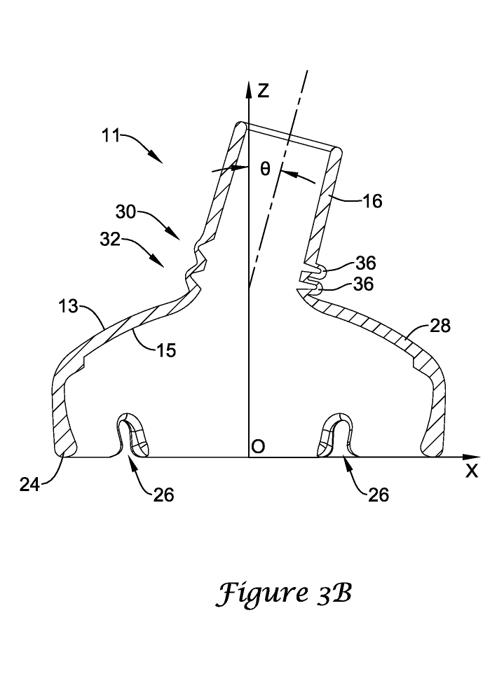

In FIG. 3, the multi-directional positioning component 32 located in the junction region 30 is also illustrated as one or more, or a plurality of bellows or pleats 36 of material. The bellows or pleats 36 may extend around at least a portion of the junction region 30. For example, the bellows 36 may extend circumferentially around the longitudinal axis of the projection 16 in the junction region 30. As shown in FIG. 3, the bellows 36 may be formed in the base portion of the projection 16 proximate the dome-shaped wall 28 of the top portion 12 of the adapter body 11.

FIGS. 3A and 3B are cross-sectional views of the adapter body 11 taken along the XZ plane of FIG. 3, with the Y-axis coming out of the page. As shown in FIGS. 3A and 3B, the bellows 36 allow the longitudinal axis of the projection 16 to be positioned at a plurality of angular positions relative to the top portion 12 of the adapter body 11. For example, in FIG. 3A, the longitudinal axis of the projection 16 is shown extending along the Z-axis and in FIG. 3B, the longitudinal axis of the projection 16 is shown extending at an angle, such as an acute angle, to the Z-axis. It can be seen from FIGS. 3A and 3B, that the bellows 36 allow the longitudinal axis of the projection 16 to be positioned at a plurality of angular orientations relative to the XY plane of the XYZ coordinate system.

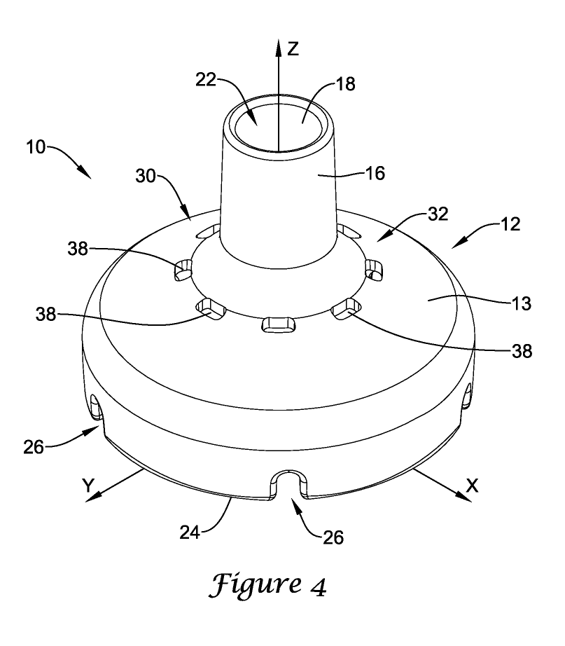

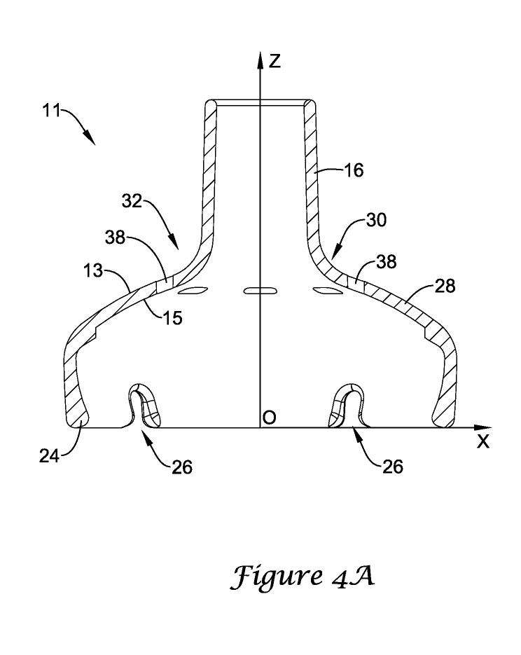

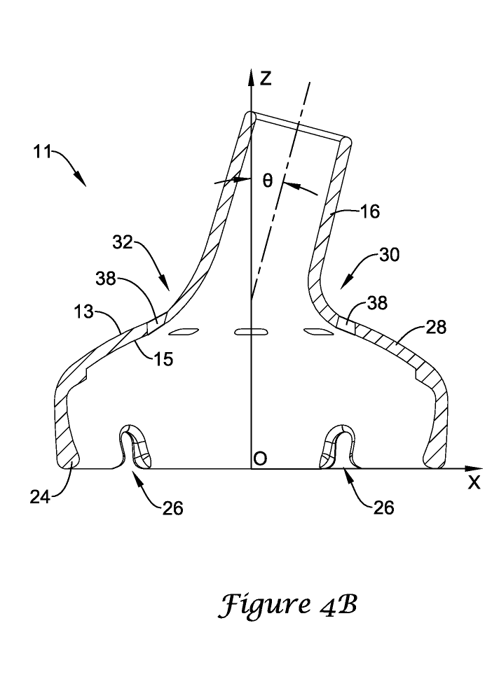

In FIG. 4, the multi-directional positioning component 32 is illustrated as one or more, or a plurality of slits or slots 38, or other type of openings, located in the junction region 30. The slits or slots 38 may extend around at least a portion of the junction region 30. For example, the slits or slots 38 may extend circumferentially around the longitudinal axis of the projection 16 in the junction region 30. As shown in FIG. 4, the slits or slots 38 may be formed in the dome-shaped wall 28 proximate the projection 16. The slits or slots 38 may extend entirely through the wall of the top portion 12 from the first surface 13 to the second surface 15, or the slits or slots 38 may extend partially through the wall of the top portion 12 from the first surface 13 toward the second surface 15 and/or from the second surface 15 toward the first surface 13. In some embodiments a plurality of slits or slots 38 may be circumferentially arranged in a polar array around the longitudinal axis of the projection 16.

FIGS. 4A and 4B are cross-sectional views of the adapter body 11 taken along the XZ plane of FIG. 4, with the Y-axis coming out of the page. As shown in FIGS. 4A and 4B, the slits or slots 38 allow the longitudinal axis of the projection 16 to be positioned at a plurality of angular positions relative to the top portion 12 of the adapter body 11. For example, in FIG. 4A, the longitudinal axis of the projection 16 is shown extending along the Z-axis and in FIG. 4B, the longitudinal axis of the projection 16 is shown extending at an angle, such as an acute angle, to the Z-axis. It can be seen from FIGS. 4A and 4B, that the slits or slots 38 allow the longitudinal axis of the projection 16 to be positioned at a plurality of angular orientations relative to the XY plane of the XYZ coordinate system.

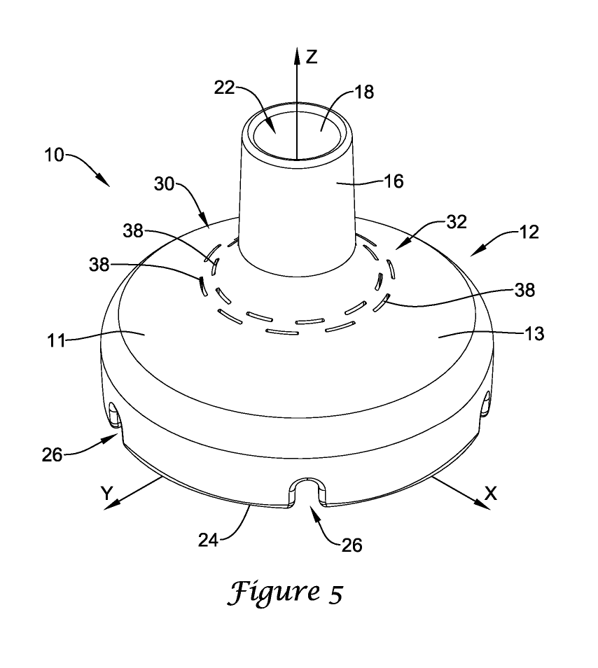

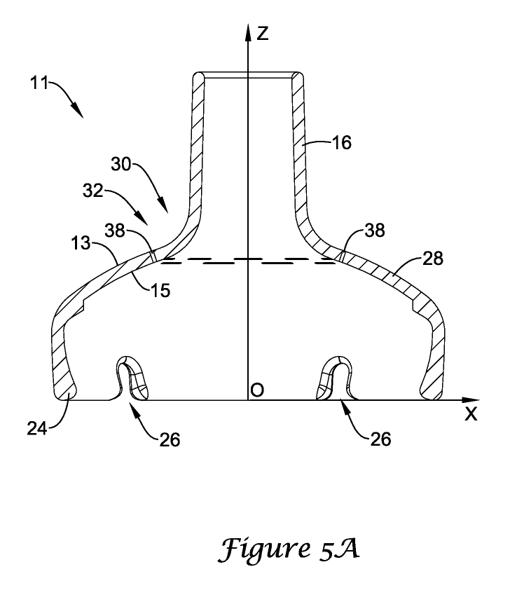

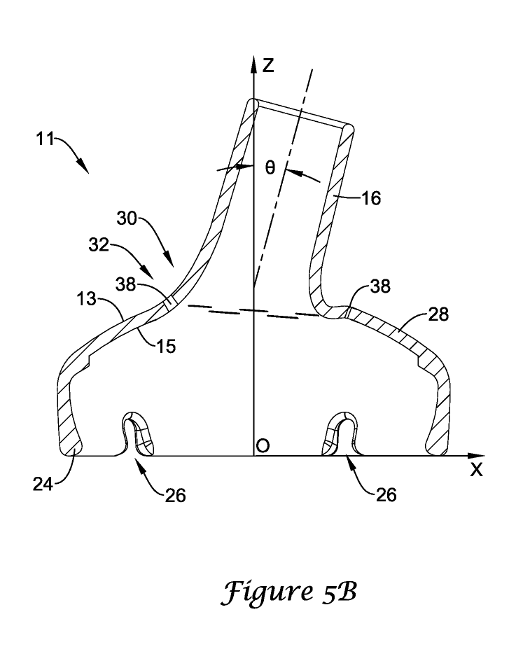

In FIG. 5, the multi-directional positioning component 32 located in the junction region 30 is also illustrated as a plurality of slits or slots 38, or other type of openings, located in the junction region 30. The slits or slots 38 may extend around at least a portion of the junction region 30. For example, the slits or slots 38 may extend circumferentially around the longitudinal axis of the projection 16 in the junction region 30. As shown in FIG. 5, the slits or slots 38 may be formed in the dome-shaped wall 28 proximate the projection 16 in a plurality of circumferential rows (e.g., two, three, four, or more rows) around the longitudinal axis of the projection 16. The slits or slots 38 may be arranged such that the slits or slots 38 of one circumferential row may or may not overlap the slits or slots 38 of an adjacent circumferential row. The slits or slots 38 may extend entirely through the wall of the top portion 12 from the first surface 13 to the second surface 15, or the slits or slots 38 may extend partially through the wall of the top portion 12 from the first surface 13 toward the second surface 15 and/or from the second surface 15 toward the first surface 13.

FIGS. 5A and 5B are cross-sectional views of the adapter body 11 taken along the XZ plane of FIG. 5, with the Y-axis coming out of the page. As shown in FIGS. 5A and 5B, the slits or slots 38 allow the longitudinal axis of the projection 16 to be positioned at a plurality of angular positions relative to the top portion 12 of the adapter body 11. For example, in FIG. 5A, the longitudinal axis of the projection 16 is shown extending along the Z-axis and in FIG. 5B, the longitudinal axis of the projection 16 is shown extending at an angle, such as an acute angle, to the Z-axis. It can be seen from FIGS. 5A and 5B, that the slits or slots 38 allow the longitudinal axis of the projection 16 to be positioned at a plurality of angular orientations relative to the XY plane of the XYZ coordinate system.

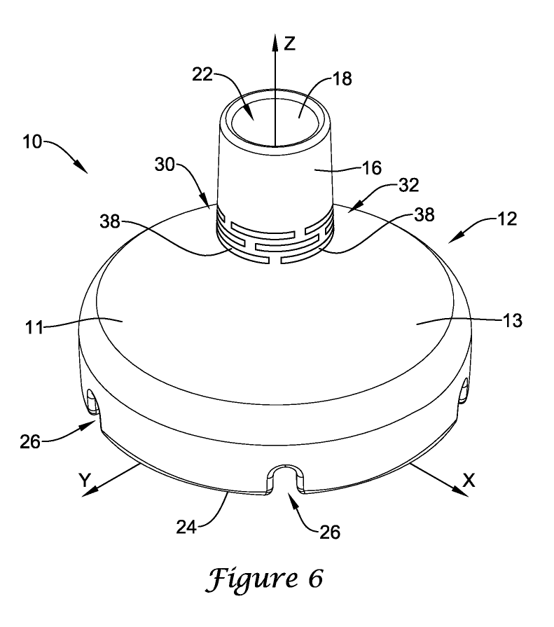

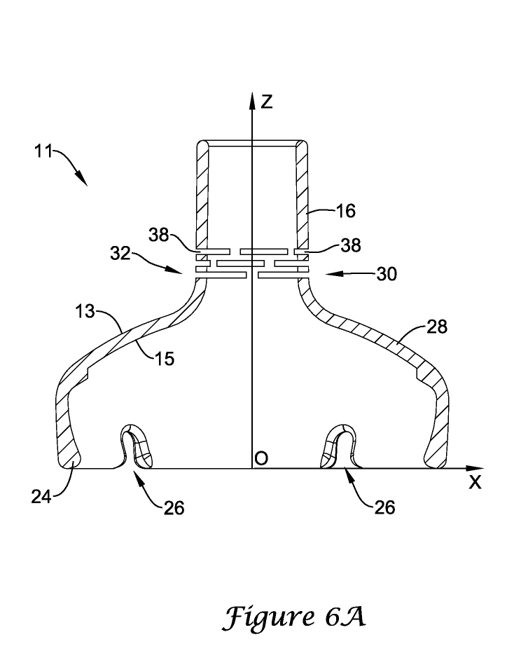

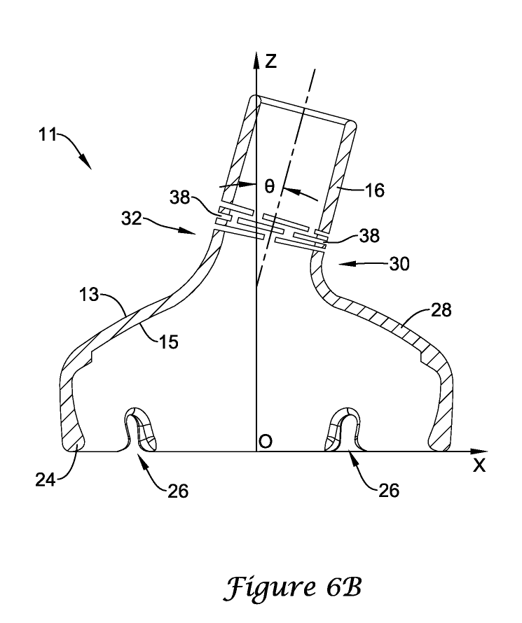

In FIG. 6, the multi-directional positioning component 32 located in the junction region 30 is again illustrated as a plurality of slits or slots 38, or other type of openings, located in the junction region 30. The slits or slots 38 may extend around at least a portion of the junction region 30. For example, the slits or slots 38 may extend circumferentially around the longitudinal axis of the projection 16 in the junction region 30. As shown in FIG. 6, the slits or slots 38 may be formed in the base portion of the projection 16 proximate the dome-shaped wall 28 of the top portion 12 of the adapter body 11 in a plurality of circumferential rows (e.g., two, three, four, or more rows) around the longitudinal axis of the projection 16. The slits or slots 38 may be arranged such that the slits or slots 38 of one circumferential row may or may not overlap the slits or slots 38 of an adjacent circumferential row. The slits or slots 38 may extend entirely through the annular wall of the projection 16 from an outer surface of the annular wall of the projection 16 to an inner surface of the annular wall of the projection 16, or the slits or slots 38 may extend partially through the annular wall from the outer surface toward the inner surface and/or from the inner surface toward the outer surface.

FIGS. 6A and 6B are cross-sectional views of the adapter body 11 taken along the XZ plane of FIG. 6, with the Y-axis coming out of the page. As shown in FIGS. 6A and 6B, the slits or slots 38 allow the longitudinal axis of the projection 16 to be positioned at a plurality of angular positions relative to the top portion 12 of the adapter body 11. For example, in FIG. 6A, the longitudinal axis of the projection 16 is shown extending along the Z-axis and in FIG. 6B, the longitudinal axis of the projection 16 is shown extending at an angle, such as an acute angle, to the Z-axis. It can be seen from FIGS. 6A and 6B, that the slits or slots 38 allow the longitudinal axis of the projection 16 to be positioned at a plurality of angular orientations relative to the XY plane of the XYZ coordinate system.

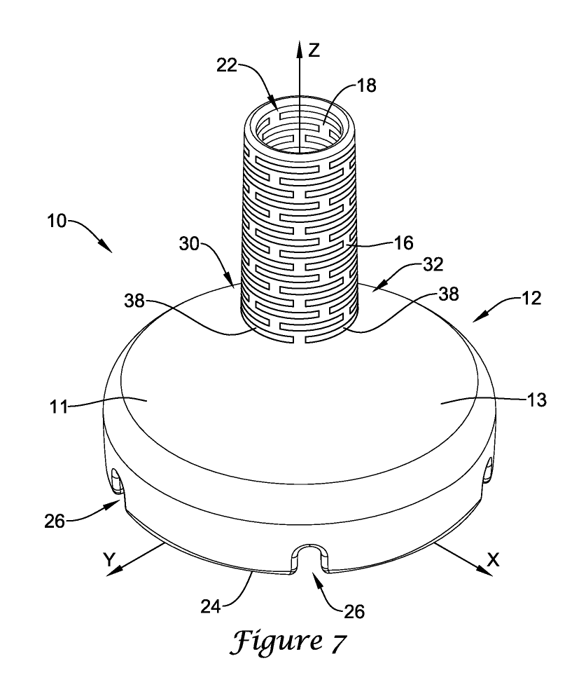

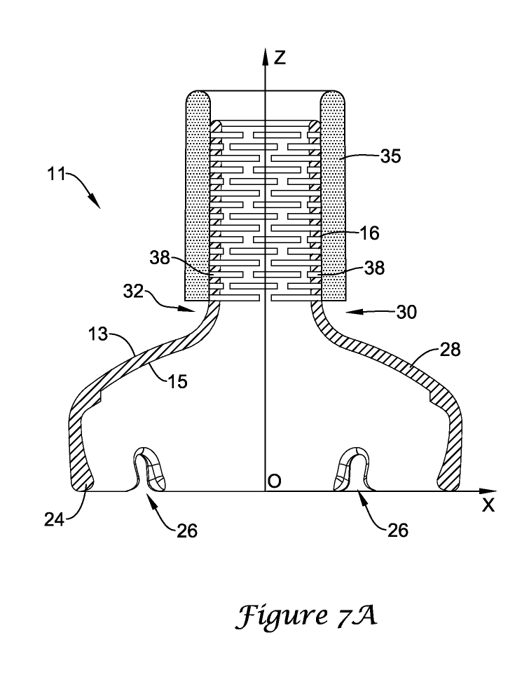

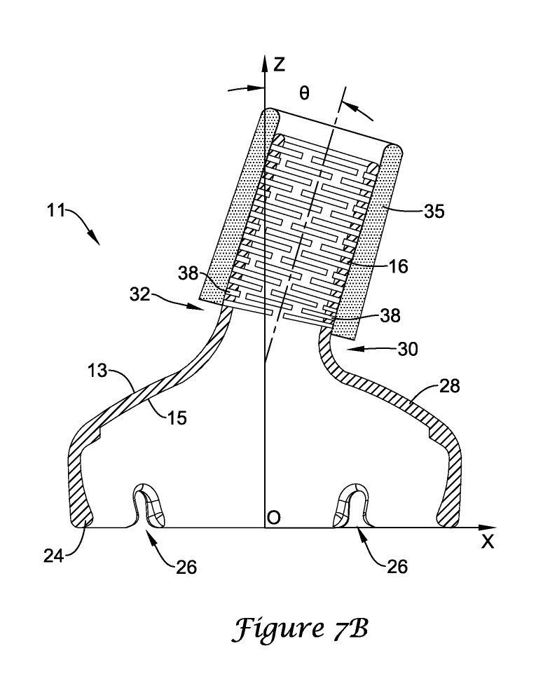

In FIG. 7, the multi-directional positioning component 32 located in the junction region 30 is again illustrated as a plurality of slits or slots 38, or other type of openings, located in the junction region 30. The slits or slots 38 may extend around at least a portion of the junction region 30. For example, the slits or slots 38 may extend circumferentially around the longitudinal axis of the projection 16 in the junction region 30. As shown in FIG. 7, the slits or slots 38 may include a plurality of circumferential rows (e.g., two, three, four, or more rows) around the longitudinal axis of the projection 16. The slits or slots 38 may be arranged such that the slits or slots 38 of one circumferential row may or may not overlap the slits or slots 38 of an adjacent circumferential row. The slits or slots 38 may extend entirely through the annular wall of the projection 16 from an outer surface of the annular wall of the projection 16 to an inner surface of the annular wall of the projection 16, or the slits or slots 38 may extend partially through the annular wall from the outer surface toward the inner surface and/or from the inner surface toward the outer surface.

Furthermore, as shown in FIG. 7, the projection 16 has a longer length allowing the projection 16 to extend further into the ear canal of a user, providing deep penetration of the projection 16 into the ear canal. The slits or slots 38 may be located along a majority of the length, a substantial portion of the length, or substantially the entire length of the projection 16. For example, the slits or slots 38 may be located along 50% or more, 60% or more, 70% or more, 80% or more, or 90% or more of the length of the projection 16. Thus, the placement of the slits or slots 38 along a length of the projection 16 provides the projection 16 with enhanced flexibility to facilitate insertion of the projection 16 deep into the ear canal of a user. In some embodiments the projection 16 may be configured to extend into the ear canal beyond the first bend of the ear canal. In such an embodiment, the projection 16 would experience a compound bend (e.g., having two or more radii of curvature in different directions and/or planes) in order to be properly positioned in the ear canal. The slits or slots 38 along a length of the projection 16 may allow the projection 16 to conform to the compound curvatures of the ear canal such that the projection 16 may be positioned beyond the first bend of the ear canal.

FIGS. 7A and 7B are cross-sectional views of the adapter body 11 taken along the XZ plane of FIG. 7, with the Y-axis coming out of the page. As shown in FIGS. 7A and 7B, the slits or slots 38 allow the longitudinal axis of the projection 16 to be positioned at a plurality of angular positions relative to the top portion 12 of the adapter body 11. For example, in FIG. 7A, the longitudinal axis of the projection 16 is shown extending along the Z-axis and in FIG. 7B, the longitudinal axis of the projection 16 is shown extending at an angle, such as an acute angle, to the Z-axis. It can be seen from FIGS. 7A and 7B, that the slits or slots 38 allow the longitudinal axis of the projection 16 to be positioned at a plurality of angular orientations relative to the XY plane of the XYZ coordinate system.

Furthermore, as shown in FIGS. 7A and 7B, a sleeve 35 may be disposed over the projection 16. The sleeve 35 can be of many different types of materials such as a polymer or foam, including polymers listed above and other materials listed below regarding the sleeve 34. A number of different types of foams exist, which may be suitable for some embodiments. For example, the sleeve 35 could be made of a sound attenuating slow recovery foam. This type of foam may allow the user to compress the sleeve 35 with his/her fingers before it is placed in the ear canal, after which it recovers its shape sufficiently so that its periphery conforms to the inner surface of the ear canal. This feature can improve the fit and comfort of the adapter 10 (and sleeve 35) in the ear canal. In addition, this type of foam can substantially block sounds from entering the ear canal other than sounds transmitted from the sound device that pass through the sound conduit 22 of the adapter body 11. This feature may be desirable because blocking extraneous sound “isolates” the ear in which the sleeve 35 is disposed from these other sounds.

The sleeve 35 may extend over and cover a majority of, substantially all of, or all of the slits of slots 38 along the projection 16. For example, the sleeve 35 may extend over 50% or more, 60% or more, 70% or more, 80% or more, or 90% or more of the length of the projection 16. The sleeve 35 may be secured to the projection 16 with a thermal bond, adhesive, interference or frictional fit, or other desired securement means. With the sleeve 35, such as a foam sleeve, surrounding the projection 16, the sleeve 35 may prevent or reduce sound leakage through the slits or slots 38 while allowing good bending or flexing of the projection 16.

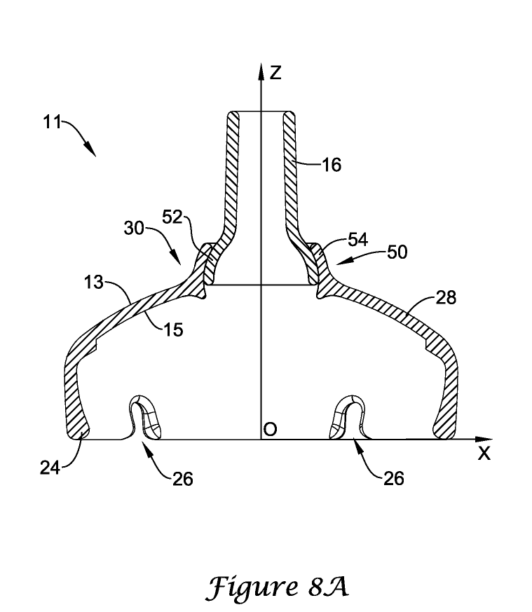

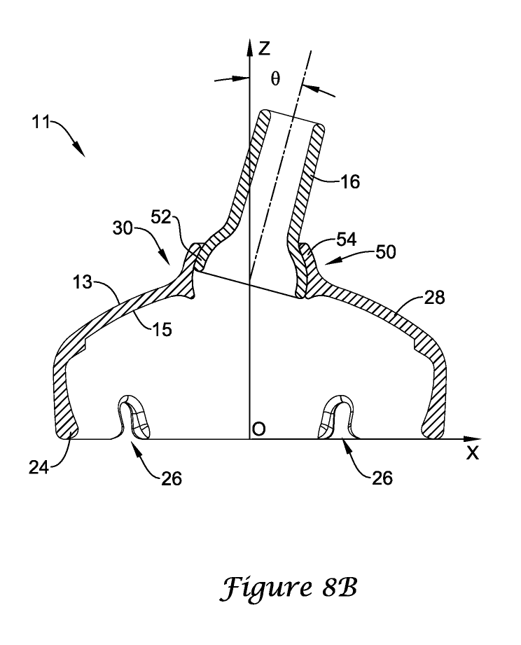

FIGS. 8A and 8B are cross-sectional views of an alternative configuration of the adapter body 11 taken along the XZ plane of FIG. 1, with the Y-axis coming out of the page, illustrating the multi-directional positioning component 32 as a ball-and-socket joint 50 in the junction region 30 between the projection 16 and the top portion 12 of the adapter body 11. The sound conduit 22 through the projection 16 may extend through the ball-and-socket joint 50. The ball-and-socket joint 50 may include a ball 52 (e.g., a spherical or hemi-spherical shaped member) having a convex surface and a socket 54 (e.g., a bowl shaped member) having a concave surface facing the convex surface of the ball 52. As shown in FIGS. 8A and 8B, the projection 16 may include the ball 52 at one end of the projection 16 and the top portion 12 of the adapter body 11 may include the socket 54 interacting with the ball 52 of the projection 16. In other embodiments, the ball 52 and socket 54 may be reversed such that the projection 16 includes the socket 54 and the top portion 12 of the adapter body 11 includes the ball 52.

As shown in FIGS. 8A and 8B, the ball-and-socket joint 50 of the junction region 30 allows the longitudinal axis of the projection 16 to be positioned at a plurality of angular positions relative to the top portion 12 of the adapter body 11. For example, in FIG. 8A, the longitudinal axis of the projection 16 is shown extending along the Z-axis and in FIG. 8B, the longitudinal axis of the projection 16 is shown extending at an angle, such as an acute angle, to the Z-axis. It can be seen from FIGS. 8A and 8B, that the ball-and-socket joint 50 allows the longitudinal axis of the projection 16 to be positioned at a plurality of angular orientations relative to the XY plane of the XYZ coordinate system.

The configuration of the ball-and-socket joint 50 allows a desired range of motion between the projection 16 and the top portion 12 of the adapter body 11. For instance, the ball-and-socket joint 50 may allow for angular rotation of the projection 16 relative to the top portion 12 of the adapter body through an arc of 5 degrees or more, 10 degrees or more, 20 degrees or more, 30 degrees or more, 45 degrees or more, or 60 degrees or more in some embodiments.

In some embodiments, it may be possible to overcome the interference fit between the ball 52 and the socket 54 of the ball-and-socket joint 50 such that the ball 52 may be removed or dissociated from the socket 54 without damaging the components of the ball-and-socket joint 50. In other embodiments, the ball-and-socket joint 50 may be constructed such that the ball 52 may not be removed or dissociated from the socket 54 without damaging the components of the ball-and-socket joint 50. In embodiments in which the ball 52 may be removed or dissociated from the socket 54, it may be possible to replace the projection 16 and/or top portion 12 of the adapter body with another projection or top portion of an adapter body as desired.

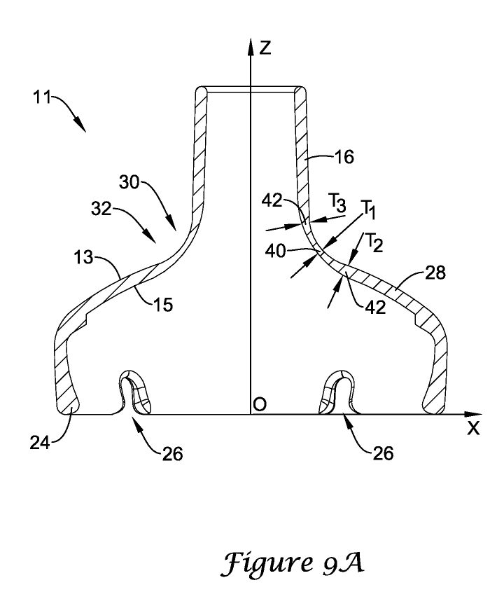

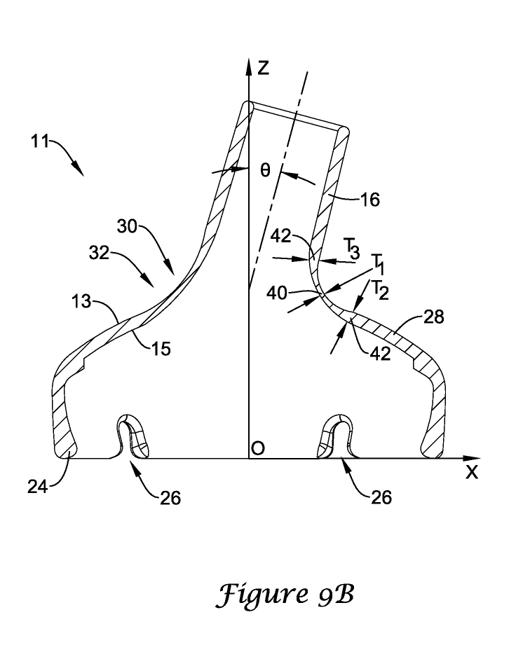

FIGS. 9A and 9B are cross-sectional views of an alternative configuration of the adapter body 11 taken along the XZ plane of FIG. 1, with the Y-axis coming out of the page, illustrating the multi-directional positioning component 32 as a reduced thickness region 40 of the junction region 30 having a thickness which is less than the thickness of the adjacent regions 42 of the junction region 30 on either side of the reduced thickness region 40. As shown in the figures, the reduced thickness region 40 may have a thickness T1, and the adjacent regions 42 of the junction region 30 may have thicknesses T2, T3 which are greater than the thickness T1 of the reduced thickness region 40. In some embodiments, the reduced thickness region 40 may be a groove, channel or recess formed in the junction region 30. The reduction in the thickness of the junction region 30 in the reduced thickness region 40 may make the reduced thickness region 40 of the junction region 30 more flexible than the adjacent regions 42, providing the ability to alter the angular orientation of the projection 16 between one of a plurality of angular orientations. In some embodiments, the thickness T1 of the reduced thickness region 40 may be less than the thickness of the annular wall of the projection 16 and/or the thickness of the top portion 12 or dome-shaped wall 28 (i.e., the distance between the first surface 13 and the second surface 15) of the adapter body 11.

As shown in FIGS. 9A and 9B, the reduced thickness region 40 of the junction region 30 allows the longitudinal axis of the projection 16 to be positioned at a plurality of angular positions relative to the top portion 12 of the adapter body 11. For example, in FIG. 9A, the longitudinal axis of the projection 16 is shown extending along the Z-axis and in FIG. 9B, the longitudinal axis of the projection 16 is shown extending at an angle, such as an acute angle, to the Z-axis. It can be seen from FIGS. 9A and 9B, that the reduced thickness region 40 allows the longitudinal axis of the projection 16 to be positioned at a plurality of angular orientations relative to the XY plane of the XYZ coordinate system.

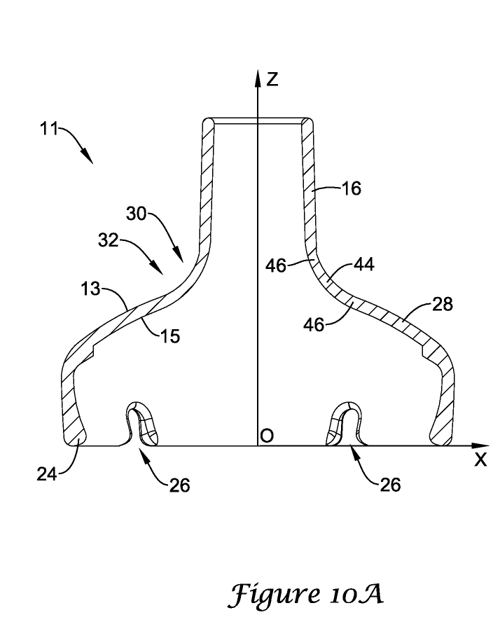

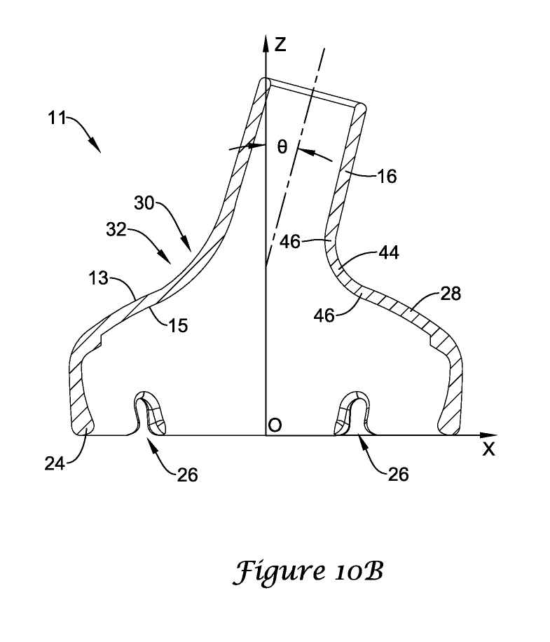

FIGS. 10A and 10B are cross-sectional views of an alternative configuration of the adapter body 11 taken along the XZ plane of FIG. 1, with the Y-axis coming out of the page, illustrating the multi-directional positioning component 32 as a first region 44 of the junction region 30 having different physical characteristics from the adjacent regions 46 of the junction region 30 on either side of the first region 44. For example, the first region 44 may have a dissimilar durometer hardness from the durometer hardness of the adjacent regions 46 of the junction region 30. For instance, the durometer hardness of the first region 44 may be greater than or less than the durometer hardness of the adjacent regions 46 of the junction region 30. In some embodiments, the durometer hardness of the first region 44 may be greater than or less than the durometer hardness of the material forming the projection 16 and/or the top portion 12 (e.g., the dome-shaped wall 28) of the adapter body 11.

In some embodiments, the first region 44 may have a dissimilar material composition from the material composition of the adjacent regions 46 of the junction region 30. For instance, the first region 44 may be formed of a first polymeric material or composition and the adjacent regions 46 may be formed of a second polymeric material or composition dissimilar to the first polymeric material or composition.

As shown in FIGS. 10A and 10B, the first region 44 of dissimilar physical characteristics allows the longitudinal axis of the projection 16 to be positioned at a plurality of angular positions relative to the top portion 12 of the adapter body 11. For example, in FIG. 10A, the longitudinal axis of the projection 16 is shown extending along the Z-axis and in FIG. 10B, the longitudinal axis of the projection 16 is shown extending at an angle, such as an acute angle, to the Z-axis. It can be seen from FIGS. 10A and 10B, that the first region 44 of dissimilar physical characteristics allows the longitudinal axis of the projection 16 to be positioned at a plurality of angular orientations relative to the XY plane of the XYZ coordinate system.

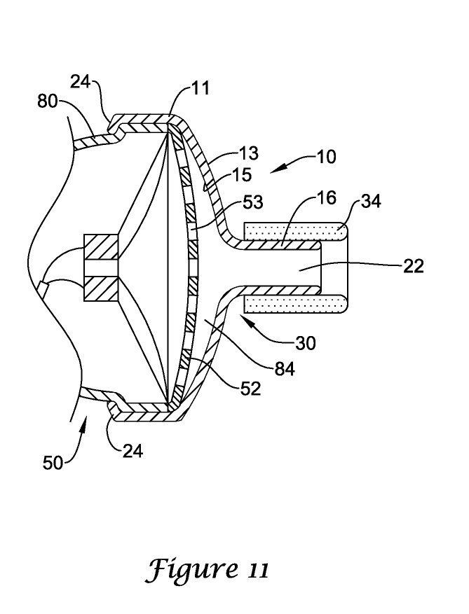

As shown in FIG. 11, the adapter 10 may be detachably coupled to the housing 80 of the earbud 50. For example, as shown in FIG. 11, the rim 24 of the adapter body 11 may extend over a portion of the housing 80, forming an interference fit, such as a frictional and/or interlocking fit, between the adapter 10 and the housing 80 of the earbud 50. A speaker or driver may be contained in the housing 80 and a speaker grille 52 may be placed in from of the speaker face to protect the speaker.

When the adapter 10 is coupled to the earbud 50, as shown in FIG. 11, the speaker grille 52 of the earbud 50, or a portion thereof, is spaced away from the inner surface 15 of the top portion 12 of the adapter body 11, thereby forming a sound transmitting cavity 84 between the inner surface 15 and the grille 52. Thus, sound emanating from through holes 53 of the speaker grille 52 may pass into the sound transmitting cavity 84. In some embodiments, the presence of the cavity 84 between the inner surface 15 and the grille 52 may facilitate positioning the projection 16 at one of a plurality of different angular positions relative to the top portion 12 of the adapter body 11. For instance, in some embodiments when the projection 16 is angled away from an equilibrium position, a portion of the junction region 30 may move closer to the speaker grille 52 and/or a portion of the junction region 30 may move further from the speaker grille 52.

It is noted that, as shown in FIG. 11, a sleeve or foam cover 34 may be coupled to the projection 16. The sleeve 34 may be coupled to the projection 16 in any number of suitable manners such as with an adhesive. In some embodiments, the sleeve 34 may be fixedly attached to the projection 16. Alternatively, the sleeve 34 may be removably attached using a coupling member, such as a burr, groove, or rim of material on the projection 16. In some embodiments, the sleeve 34 may be generally cylindrical in shape, however, other shapes are contemplated. The sleeve 34 may include an outer peripheral surface which contacts the walls of the ear canal of a user, and an axial lumen that extends into the sleeve 34. In some embodiments, the lumen extends into only a portion of sleeve 34, however, in other embodiments, the lumen extends all the way through the sleeve 34. Some of the features and characteristics of a suitable sleeve 34 can be found in U.S. Pat. No. 5,920,636, the disclosure of which is incorporated herein by reference.

The sleeve 34 may also include a thin layer of a sound-transmitting material or scrim (e.g., preferably a reticulated open cell foam or partially open cell foam) that helps prevent detritus or cerumen from the ear canal from entering the sound conduit 22 of the projection 16 of the adapter body 11.

The sleeve 34 can be of many different types of materials such as a polymer or foam. Some example polymers are listed above. A number of different types of foams exist, which may be suitable for some embodiments. For example, the sleeve 34 could be made of a sound attenuating slow recovery foam. This type of foam may allow the user to compress the sleeve 34 with his/her fingers before it is placed in the ear canal, after which it recovers its shape sufficiently so that its periphery conforms to the inner surface of the ear canal. This feature can improve the fit and comfort of the adapter 10 (and sleeve 34) in the ear canal, and may provide retention of the adapter 10 in the ear canal. In addition, this type of foam can substantially block sounds from entering the ear canal other than sounds transmitted from the sound device that pass through the sound conduit 22 of the adapter body 11. This feature may be desirable because blocking extraneous sound “isolates” the ear in which the sleeve 34 is disposed from these other sounds. In some embodiments, the sleeve 34, which may seal around the periphery of the ear canal, may enhance the frequency response experienced by the user.

It is believed that isolating an ear from other sounds (i.e., sounds not originating from the sound device) allows the user to better process sound coming from the sound device, even when the device is only in one ear with the other ear receiving the extraneous sounds. This allows the user to better distinguish the sounds from the sound device from other sounds that could be distracting. This feature may be particularly useful when the sound device is an earbud connected to a telephone because the user would be able to adequately hear and distinguish voices from the telephone from other sounds or voices that might be present in the area. This feature also reduces the likelihood that sounds originating from the sound device would be confused with extraneous sounds, even when the user's other ear does not have any sound device disposed therein. Moreover, by reducing the amount of unwanted sound that enters the ear, a lesser degree of energy can be delivered to the eardrum for the same level of sound perception and intelligibility. This can protect the eardrum from damage that could be caused by exposure to greater amounts of energy or otherwise help preserve or enhance the long-term health of the ear.

Where it is desirable to have sounds enter the ear both through the sound device and the sleeve 34, the sleeve 34 can be of a more sound transmissive foam such as open cell foam or a reticulated open cell foam selected for the amount of sound transmission desired. Typically, such open cell foams are sufficiently compressible so that the periphery will conform to the inner surface of the ear canal as the sleeve 34 is pushed into the ear canal. It can be appreciated that the use of a number of other types of foams and similar materials are contemplated. For example, in some embodiments partially open cell foams may be used. In addition, a plethora of other suitable materials are contemplated, including silicone rubber and elastomeric polymers.

In other embodiments, the adapter 10 may not include a sleeve attached to the projection 16. For instance, in some embodiments the projection 16 may be configured to be inserted into the ear canal of a user in the absence of a sleeve. For example, the projection 16 may be formed of a suitable durometer polymeric material and/or may include a configuration which could be inserted directly into the ear canal without injuring the walls of the ear canal. In some embodiments, the diameter of the projection 16 may be sized to substantially fill the ear canal, and thus substantially isolate the ear canal from extraneous sounds. For example, in some embodiments the end of the projection 16 could be formed with a bulbous portion which may be fitted into the ear canal and/or substantially fill the ear canal.

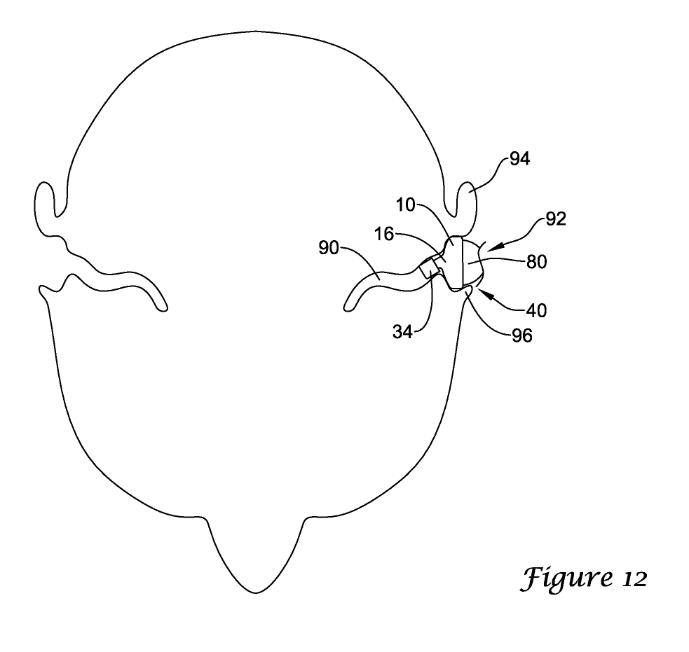

FIG. 12 illustrates the adapter 10, detachably coupled to the housing 80 of an earbud 40, placed in the auditory anatomy of a user, such that the top portion 12 of the adapter body 11, such as the dome-shaped wall 28, is placed in the concha 92 of the ear 94 while the sleeve 34 and/or projection 16 are inserted at least partially into the ear canal 90. The outer surface 13, which may be a convex surface, of the top portion 12 of the adapter body 11 may face and/or generally follow the shape of the bowl of the concha 92, and may reside posterior of the tragus 96 of the ear 94. In some embodiments, the anatomical shape of the ear, including the curvature of the concha 92 and the presence of the tragus 96, may provide retention means for retaining the adapter 10 in the ear 94. In some embodiments, the interference fit between the projection 16 and/or sleeve 34 may provide adequate retention means for retaining the adapter 10 in the ear 94.

Depending on the angular relationship of the user's ear canal 90 relative to the bowl of the concha 92 of the user's ear 94, the projection 16 may be positioned at one of a plurality of angular positions relative to the top portion 12 of the adapter body 11 such that the top portion 12 of the adapter body 11 comfortably rests in the bowl of the concha 92 while the projection 16 extends into the ear canal 90. The presence of the multi-directional positioning component 32 allows the angular orientation of the projection 16 to be tailored to fit the orientation of the ear canal 90 of a specific user.

Those skilled in the art will recognize that the present invention may be manifested in a variety of forms other than the specific embodiments described and contemplated herein. Accordingly, departure in form and detail may be made without departing from the scope and spirit of the present invention as described in the appended claims.

What is claimed is:

1. An adapter configured to be detachably coupled to an earbud-type sound device or other sound device, the adapter comprising:
an adapter body having a top portion, a bottom portion which is configured to be detachably coupled to a sound device, and a projection extending from the top portion at a junction region between the projection and the top portion of the adapter body;
the projection including a sound conduit extending from an opening in the top portion of the adapter body;
wherein the junction region includes a multi-directional positioning component allowing the projection to be positioned at a plurality of angular positions relative to the top portion of the adapter body.

2. The adapter of claim 1, wherein the projection is oriented in a first position in which the projection extends from the top portion of the adapter body at a first angular orientation relative to the top portion, and wherein an applied force to the projection moves the projection to a second position in which the projection extends from the top portion of the adapter body at a second angular orientation relative to the top portion, wherein the projection is biased to return to the first position from the second position when the applied force is removed.

3. The adapter of claim 1, wherein the bottom portion of the adapter body includes a rim adapted to fit over and generally extend around a perimeter of the earbud-type sound device.

4. The adapter of claim 3, wherein the rim of the bottom portion lies in an XY plane of an XYZ coordinate system;
wherein the projection includes a longitudinal axis extending at an angle to the XY plane of the XYZ coordinate system;
wherein the multi-directional positioning component allows the longitudinal axis of the projection to be positioned at a plurality of angular positions relative to the XY plane of the XYZ coordinate system.

5. The adapter of claim 4, wherein the longitudinal axis of the projection lies along a Z-axis of the XYZ coordinate system;
wherein the multi-directional positioning component allows the longitudinal axis of the projection to angle away from the Z-axis in a plurality of directions.

6. The adapter of claim 5, wherein a position in which the longitudinal axis of the projection lies along the Z-axis is an equilibrium position, and wherein when the longitudinal axis of the projection is angled away from the Z-axis, the projection is biased to return to the equilibrium position.

7. The adapter of claim 1, wherein the multi-directional positioning component includes one or more bellows of material extending around at least a portion of the junction region.

8. The adapter of claim 1, wherein the multi-directional positioning component includes one or more slots or slits extending around at least a portion of the junction region.

9. The adapter of claim 1, wherein the multi-directional positioning component is a reduced thickness region of the junction region having a thickness which is less than a thickness of the junction region on either side of the reduced thickness region.

10. The adapter of claim 1, wherein the multi-directional positioning component is a region of the junction region having a durometer hardness dissimilar to a durometer hardness of an adjacent region of the junction region.

11. The adapter of claim 1, wherein the multi-directional positioning component is a region of the junction region having a dissimilar material composition from a material composition of an adjacent region of the junction region.

12. The adapter of claim 1, wherein the multi-directional positioning component includes one or more grooves extending around at least a portion of the junction region.

13. An adapter for removably coupling to an earbud, the adapter comprising:
an adapter body including a top portion having a first surface and an opposing second surface;
a projection extending from the first surface of the top portion of the adapter body at a junction region between the projection and the top portion of the adapter body, the projection including a sound conduit extending from an opening in the second surface of the adapter body;
a sleeve disposed over at least a portion of the projection, the sleeve being configured to be positioned at least in part into the ear canal of a user; and
wherein the junction region between the projection and the adapter body includes a region of enhanced flexibility providing multi-directional angular orientation of the projection relative to the top portion of the adapter body at the junction region.

14. The adapter of claim 13, wherein the region of enhanced flexibility provides omni-directional angular orientation of the projection relative to the top portion of the adapter body.

15. The adapter of claim 13, wherein the region of enhanced flexibility includes one or more bellows of material located in the junction region.

16. The adapter of claim 13, wherein the region of enhanced flexibility includes one or more slots or slits located in the junction region.

17. The adapter of claim 13, wherein the region of enhanced flexibility is a reduced thickness region of the junction region having a thickness which is less than a thickness of the junction region on either side of the reduced thickness region.

18. The adapter of claim 17, wherein the projection has an annular wall having a thickness, and wherein the top portion of the adapter body has a thickness between the first surface and the second surface;
wherein the reduced thickness region has a thickness less than the thickness of the annular wall of the projection and less than the thickness of the adapter body.

19. The adapter of claim 13, wherein the region of enhanced flexibility includes one or more grooves located in the junction region.

20. The adapter of claim 13, wherein the region of enhanced flexibility is a region of the junction region having a durometer hardness dissimilar to a durometer hardness of an adjacent region of the junction region.

21. The adapter of claim 13, wherein the region of enhanced flexibility is a region of the junction region having a dissimilar material composition from a material composition of an adjacent region of the junction region.

22. The adapter of claim 13, wherein the adapter body includes a bottom portion including a rim configured to detachably couple the adapter to an earbud, wherein the rim lies in an XY plane of an XYZ coordinate system;
wherein the projection includes a longitudinal axis lying along a Z-axis of the XYZ coordinate system;
wherein the region of enhanced flexibility allows the angular orientation of the projection relative to the top portion of the adapter body to be altered such that the longitudinal axis of the projection angles away from the Z-axis.

23. The adapter of claim 13, wherein the adapter body includes a bottom portion including a rim configured to detachably couple the adapter to an earbud, wherein the rim lies in an XY plane of an XYZ coordinate system;
wherein the projection includes a longitudinal axis extending at an angle to the XY plane of the XYZ coordinate system;
wherein the region of enhanced flexibility allows the angular orientation of the projection relative to the top portion of the adapter body to be altered such that the angle between the longitudinal axis of the projection and the XY plane of the XYZ coordinate system is changed.

24. An adapter configured to be attached to an earbud-type sound device, the adapter comprising:
a dome-shaped wall configured to be disposed adjacent a speaker face of the earbud-type sound device; and
a projection extending at an angle from the dome-shaped wall at a junction region between the projection and the dome-shaped wall, the projection including a sound conduit for directing sound through the projection into an ear canal of a user;
wherein the junction region between the projection and the dome-shaped wall includes a multi-directional positioning component allowing the projection to be positioned at a plurality of angular positions relative to the dome-shaped wall in order that the adapter can fit comfortably in a variety of different users' ears.

25. The adapter of claim 24, wherein the adapter may be fitted in a user's ear such that the dome-shaped wall of the adapter rests against a concha of the user's ear while at least a portion of the projection is inserted into an ear canal of the user's ear.

26. The adapter of claim 25, wherein the orientation of the ear canal relative to the concha of an ear of a user is different for a variety of different users, wherein the angular position of the projection relative to the dome-shaped wall adjusts to fit the orientation of a specific user.

27. The adapter of claim 24, wherein the projection is oriented in a first position in which the projection extends from the dome-shaped wall of the adapter body at a first angular position relative to the dome-shaped wall, and wherein an applied force to the projection moves the projection to a second position in which the projection extends from the dome-shaped wall of the adapter body at a second angular position relative to the dome-shaped wall, wherein the projection is biased to return to the first position from the second position when the applied force is removed.

28. An adapter for removably coupling to an earbud, the adapter comprising:
an adapter body including a top portion having a first surface and an opposing second surface;
a projection extending from the first surface of the top portion of the adapter body at a junction region between the projection and the top portion of the adapter body, the projection including a sound conduit extending from an opening in the second surface of the adapter body;
a sleeve disposed over at least a portion of the projection, the sleeve being configured to be positioned at least in part into the ear canal of a user; and
wherein the junction region between the projection and the adapter body includes means for positioning the projection at a plurality of angular positions relative to the top portion of the adapter body.

29. The adapter of claim 28, wherein the adapter may be fitted in a user's ear such that the top portion of the adapter rests against a concha of the user's ear while at least a portion of the projection is inserted into an ear canal of the user's ear.

30. The adapter of claim 29, wherein the orientation of the ear canal relative to the concha of an ear of a user is different for a variety of different users, wherein the means for positioning the projection at a plurality of angular positions relative to the top portion of the adapter body permits the adapter to be tailored to fit the orientation of a specific user.
